(19) United States
(12) Patent Application Publication
(10) Pub. No.: US 2025/0192135 A1
(43) Pub. Date: Jun. 12, 2025

(54) Method for Producing an Electrode for an Electrochemical Cell, Composite Electrode, and Electrochemical Cell

(71) Applicant: Bayerische Motoren Werke Aktiengesellschaft, Muenchen (DE)

(72) Inventors: Peter LAMP, Landsberg am Lech (DE); Thomas WOEHRLE, Muenchen (DE); Nina ZENSEN, Pfaffenhofen an der llm (DE)

(21) Appl. No.: 18/845,499

(22) PCT Filed: Feb. 22, 2023
(86) PCT No.: PCT/EP2023/054459

§ 371 Date: Sep. 10, 2024

(30) Foreign Application Priority Data
Mar. 14, 2022 (DE) 10 2022 105 852.2

(51) Int. Cl. H01M 4/04; H01M 4/02; H01M 4/1393; H01M 4/1395; H01M 4/62; H01M 4/74; H01M 10/0525

(52) U.S. Cl. CPC H01M 4/0435; H01M 4/0404; H01M 4/1393; H01M 4/1395; H01M 4/621; H01M 4/625; H01M 4/742; H01M 4/745; H01M 10/0525; H01M 2004/021

(57) ABSTRACT

A method for producing a composite electrode for an electrochemical cell is provided herein. The method includes: applying a self-supporting electrode film and/or a dry electrode mixture to a porous collector foil; and compressing the self-supporting electrode film and/or the dry electrode mixture and the porous collector foil to form a composite electrode. The self-supporting electrode film and/or the dry electrode mixture includes a multiplicity of dry-processed particles, the multiplicity of dry-processed particles containing at least a binder, a conductivity additive, and an active material; the porous collector foil ahs openings that extend through the porous collector foil; the electrode film or the dry electrode mixture is pressed at least partially into the openings of the porous collector foil; and the composite electrode is free from adhesion promoters. A composite electrode is further provided. An electrochemical cell including at least one composite electrode is further provided.

### BACKGROUND AND SUMMARY

The present disclosure relates to a method for producing an electrode for an electrochemical cell, to a composite electrode obtainable by this method, and to an electrochemical cell featuring such a composite electrode.

For the production of electrodes for electrochemical cells, there are methods known in which solvent-based coating compounds, referred to as slurries, are applied to collector foils; this coating compound comprises an electrochemical active material, a binder and additives such as conductivity additives, and a carrier solvent. A drying step is needed thereafter, as a slurry typically also comprises solvents such as N-methyl-2-pyrrolidone (NMP), which must be removed so as not to remain in the electrode or in an electrochemical cell featuring such an electrode. After the coating operation, therefore, these solvents must be removed before the electrode can be installed in an electrochemical cell. Consequently, wet-chemical electrode production methods are associated with additional costs and considerable work. For example, the carrier solvent has to be drawn off, removed by condensation, and purified. This involves considerable logistical work and considerable energy.

US 2013/0157141 A1 discloses a method for producing self-supporting electrodes that avoids the use of carrier solvents. It does so by mixing dry, free-flowing particles of active material, binder, and additives (such as, for example, conductive carbon black, also referred to as carbon black in the technical parlance) with one another and processing the mixture into a self-supporting—that is, inherently stable—electrode film. Serving as binders are, in particular, “fibrillatable” polymers such as polytetrafluoroethylene (PTFE). The self-supporting electrodes are subsequently applied to a metallic collector foil, a rolled aluminum foil for example, with the collector foil having previously been etched and provided with an adhesion promoter layer (also referred to as primer coatings).

A disadvantage of this method is the unavoidable need for adhesion promoters to be used between self-supporting electrode film and collector foil in order to be able to generate a sufficiently stable bond or adhesion between electrode film and collector film. The additional coating associated with this acts as dead material in an electrochemical cell using such an electrode, and therefore reduces the volumetric and gravimetric energy density of the cell.

Moreover, the application of the adhesion promoter typically takes place wet-chemically and/or requires wet-chemical etching or other pretreatment of the collector foil. The self-supporting electrode film, moreover, must be laminated hot to the collector foil in order to achieve sufficient adhesion. Accordingly, there continue to be multiple cost-intensive and time-consuming steps required, some of which have to take place wet-chemically.

The object of the present disclosure is to provide a possibility for further reducing the work in production and the costs of electrodes for electrochemical cells. In particular it is to be possible to do without wet-chemical operations or at least reduce the number of such operations. There is preferably to be no need for wet coating to apply a primer coating and/or for hot lamination.

The object is achieved by a method for producing an electrode for an electrochemical cell, comprising steps as follows: first a self-supporting electrode film and/or a dry electrode mixture is provided, with the self-supporting electrode film and/or the dry electrode mixture comprising a multiplicity of dry-processed particles, wherein the multiplicity of dry-processed particles contains at least a binder, a conductivity additive, and an active material. Moreover, a porous collector foil is provided, wherein the porous collector foil has openings which extend through the porous collector foil. The self-supporting electrode film and/or the dry electrode mixture is applied on the porous collector foil and compressed to form a composite electrode, wherein the electrode film and/or the dry electrode mixture is pressed at least partially into the openings of the porous collector foil, and wherein the composite electrode is free from adhesion promoters.

A “self-supporting electrode film” is understood here and below to refer to a dimensionally stable, more particularly inherently stable, electrode film which can be handled separately, in other words without having to have been applied to an additional carrier material, more particularly without having to have already been applied to a collector foil.

The “dry electrode mixture” refers here and below to a mixture of the multiplicity of dry-processed particles; the dry electrode mixture does not per se have an inherently stable form but is instead compressed directly into the porous collector foil, by being rolled in or calendered in, for example, to give the composite electrode.

This makes it possible for the dry electrode mixture to be rolled or calendered directly into the porous collector; in the resulting composite electrode, the porous collector may be aligned centrally or asymmetrically in the composite electrode.

In particular, to give the method a particularly simple configuration, either a self-supporting electrode film or a dry electrode mixture is used.

The self-supporting electrode film is produced in particular according to the method for generating a self-supporting electrode film as described in US 2013/0157141 A1.

The dry electrode mixture may use the same components which may also be employed in accordance with US 2013/0157141 A1 for producing self-supporting electrode films.

There are no further limitations on the nature of the (electrode) binders, conductivity additives, and active materials in the electrode film, provided that self-supporting electrode films or dry electrode mixtures can be produced from them.

In one variant, the electrode film has a density of 0.5 g/cm3 or higher.

If the composite electrode is an anode, the electrode film in one variant comprises 30 to 98 percent by weight of graphite, 70 percent by weight or less of silicon, 9 percent by weight or less of carbon black, and 0.5 to 10 percent by weight of binder, based in each case on the total weight of the electrode film.

The collector foil is a metallic, metal-containing or at least electrically conducting carrier foil which can serve as a current collector in the composite electrode.

Particularly suitable are expanded aluminum metals, from Bender GmbH (Germany) for example, if the electrode obtained in the production method of the present disclosure is a cathode.

The term “composite electrode” refers to the electrode produced via the method of the present disclosure and to the totality composed of collector foil and electrode films applied on the collector foil and/or compressed with the collector foil, which therefore serve as electrode coatings of the collector foil.

In accordance with the present disclosure, the composite electrode, and in particular the porous collector foil as well, are free from adhesion promoters. This means that the composite electrode has no primer coating of the kind known in the prior art. In this way, no additional method steps are necessary for applying such primer coatings with adhesion promoter. As a result, in particular, the known wet-chemical operations for applying primer coatings, along with operation costs, are avoided.

It has been recognized that the use of a porous collector foil removes the need for additional adhesion promoters while nevertheless affording a sufficiently stable and reliable connection between the electrode film composed of dry-processed particles and the collector foil. This also cuts out any pretreatment steps that would have to be carried out to allow adhesion promoters to be applied to a collector foil.

The attributed basis for this effect is that the openings of the porous collector foil provide a greater contact area between electrode film or electrode mixture and porous collector foil than is the case for nonporous collector foils, also referred to as “solid foils”. A kind of mechanical interlocking or anchoring between the electrode film and the collector foil is generated in this way. Moreover, adhesion forces between the components involved are increased because of the greater surface area of the porous collector foil.

In this connection, the compressing of the self-supporting electrode film and/or of the dry electrode mixture produces sufficient contact and reliable adhesion between the electrode film and the porous collector foil.

In particular, the electrode film may be pressed at least partially through the openings in the porous collector foil, meaning that, even if the self-supporting electrode film is applied only to a single side of the porous collector foil, the composite electrode obtained has an electrode film present on both sides of the porous collector foil.

The compressing takes place preferably via calendering, more particularly via cold calendering.

Calendering enables a particularly controlled operating regime, in which a uniform force is provided for compressing the electrode film.

“Cold calendering” means that the calendering is carried out at a temperature in the range from 10° C. to 60° C., more particularly from 10° C. to 50° C., preferably from 15° C. to 30° C.—for example, at room temperature. In this way, costs for generating higher temperatures can be saved, and deformations due to temperature differences can be avoided or at least reduced.

Because of the openings in the porous collector foil, the porous collector foil is more flexible/more elastic than a collector foil without such openings. This gives the porous collector foil a lower material stress and a reduced warpage on calendering, meaning that even when high forces are used during the calendering step, the electrodes produced have a uniform shape, in other words, no warpage or at least reduced warpage. This also results in fewer corrugations, creases, cracks, and cambers.

“Camber” here denotes the deviation from linearity—that is, the deviation from a uniform contour with lengthways sides that are aligned substantially parallel to one another—after calendering.

Porous collector foils have the advantage, moreover, of a weight reduction in comparison to continuous collector foils, such as rolled foils, for example. Porous collector foils are familiar from lightweight construction, are available worldwide, and are easy to process.

The porous collector foil is more particularly a perforated foil, a punched foil, a cut-out foil, an etched foil, a slit foil, an expanded metal or a metallized fabric.

Porous collector foils of this kind may be readily produced from continuous collector foils, such as rolled foils, for example, being so-called “solid foils”, and are inexpensively available.

The porous collector foil may be an expanded metal. The high surface area of expanded metals endows them with good mechanical interlocking or anchoring between electrode film and porous collector foil.

Metallized fabrics feature particularly high flexibility in combination with low intrinsic weight. The energy density of electrochemical cells with composite electrodes produced in accordance with the present disclosure can be further increased in this way.

Metallized glass fabrics as collectors in lithium-ion cells are described for example in DE 10 2018 000272 A1.

To increase still further the interaction between electrode film and porous collector foil, the porous collector foil may be cleaned and/or surface-activated before the application of the self-supporting electrode film. Contaminants, process oils for example, are removed from the collector foil in this way.

Particularly good cleaning outcomes are achievable with a corona surface treatment.

Alternatively, the collector foil may be pretreated by plasma etching.

Also possible in principle is the wet-chemical cleaning of the porous collector foil, by pickling with aqueous sodium hydroxide, for example. However, wet-chemical cleaning is less preferable, to allow the method of the present disclosure to be carried out with as few wet-chemical steps as possible or ideally none.

In one variant, a first self-supporting electrode film is applied on a top side of the porous collector foil and a second self-supporting electrode film is applied on a bottom side, opposite from the top side, of the porous collector foil, wherein both the first self-supporting electrode film and the second self-supporting electrode film are compressed on the porous collector foil.

In this way, a corresponding electrode film can be applied and secured on both sides of the porous collector foil in a single method step, so making it possible to reduce further the total time for applying the electrode films.

The compressing, moreover, in addition to the interactions between the respective electrode films and the porous collector, also produces an interaction between the two electrode films, which are exposed to pressure from the top side and the bottom side, allowing the interaction of the two compressed electrode films with one another to provide for further mechanical stabilization of the composite electrode produced.

An operation of this kind, moreover, can be carried out in a vertical orientation of the collector foil, in which the electrode film is compressed, for example, by calendering rolls arranged oppositely and on both sides.

The method is preferably carried out solventlessly. In this way, the costs of the method can be lowered further and the use of environmentally objectionable solvents, such as NMP, for example, can be omitted.

The object of the present disclosure is additionally achieved by a composite electrode for an electrochemical cell, obtainable by the method described above.

More particularly, the composite electrode is obtained by the method described above.

The composite electrode has particularly favorable producibility and features only small amounts of dead material or none.

Additionally, the object of the present disclosure is achieved by an electrochemical cell comprising at least one composite electrode of the type described above.

The electrochemical cell of the present disclosure has in particular a high energy density, as no additional coating with adhesion promoters need be present.

More particularly, all electrodes of the electrochemical cell are composite electrodes of the type described above.

The electrochemical cell is preferably a lithium-ion cell.

The term “lithium-ion cell” is used in this context synonymously for all designations commonplace in the prior art for lithium-containing galvanic elements and cells, such as, for example, lithium battery, lithium cell, lithium polymer cell, lithium-ion battery cell, and lithium-ion accumulator. The term in particular includes rechargeable batteries (secondary batteries).

Further features and properties of the present disclosure are elucidated by the comprehensive description below of illustrative embodiments, which are not to be understood in a limiting sense, and also by the figures.

### BRIEF DESCRIPTION OF THE DRAWINGS

FIG. 1 shows a method for producing an electrode as known from the prior art,

FIG. 2 shows a schematic representation of a first embodiment of a composite electrode with the invention, as obtainable via a method of the invention,

FIG. 3 shows a schematic representation of a second embodiment of a composite electrode of the invention,

FIG. 4 shows a schematic representation of a third embodiment of a composite electrode of the invention,

FIG. 5 shows a block diagram of the method of the invention for producing an electrode, more particularly the composite electrodes of FIGS. 2 to 4,

FIG. 6 shows a schematic representation of component steps of a first embodiment of the method of the invention from FIG. 5, and

FIG. 7 shows a schematic representation of a component step of a second embodiment of the method of the invention from FIG. 5.

### DETAILED DESCRIPTION OF THE DRAWINGS

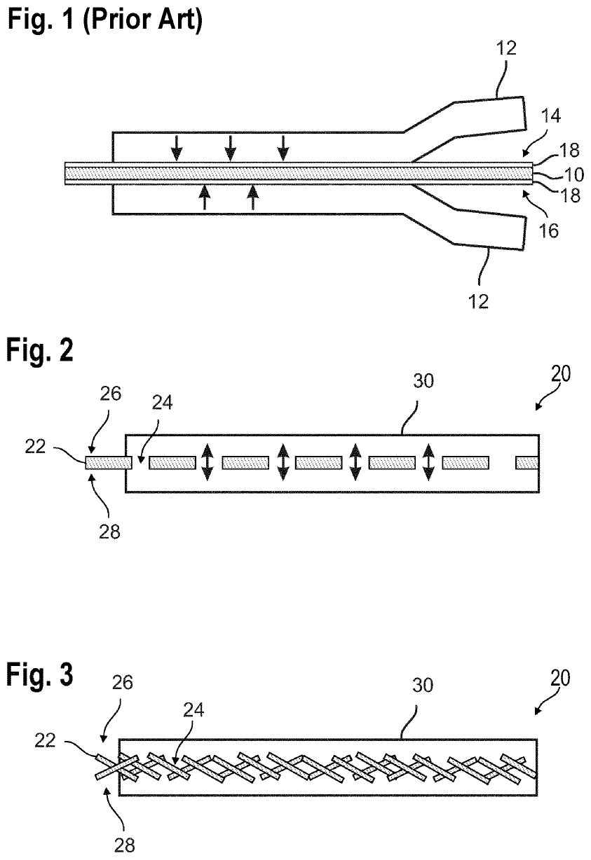

Represented schematically in FIG. 1 is a method for producing an electrode, as known from the prior art.

In this method, an electrode film 12 is applied to a collector foil 10, consisting for example of a metal such as copper or aluminum, on both sides, in other words both in the direction of a top side 14 of the collector foil 10 and in the direction of a bottom side 16, opposite from the top side 14, of the collector foil 10.

The electrode film 12 is pressed onto the top side 14 and bottom side 16, respectively, by hot lamination, in other words at a temperature of typically about 110° C. to 150° C. and with a specified pressure, as indicated by arrows in FIG. 1.

To provide sufficient adhesion between collector foil 10 and the electrode films 12, a primer coating 18 containing an adhesion promoter is applied both to the top side 14 and to the bottom side 16.

This adhesion promoter has to be applied to the collector foil 10 in an upstream step, and remains as dead material in the completed electrode.

Represented in FIG. 2 is a schematic view in section of a composite electrode 20 of the invention, as obtained by a method of the present disclosure for producing an electrode—this method will be described more closely later on.

The composite electrode 20 comprises a porous collector foil 22, comprising multiple openings 24 which extend through the porous collector foil 22.

In other words, the openings 24 run from a top side 26 of the porous collector foil 22 to a bottom side 28 of the porous collector foil 22.

FIG. 2 shows a view in section which runs straight through the openings 24. It is understood that the regions of the porous collector foil 22 that are represented as separated in FIG. 2 are connected to one another at other points along a direction of transverse extent of the porous collector foil 22.

The composite electrode 20 further comprises a self-supporting electrode film 30, comprising a multiplicity of dry-processed particles, with the multiplicity of dry-processed particles containing a binder, a conductivity additive, and an active material.

There are no further limitations on the nature of the binders, conductivity additives, and active materials, provided that self-supporting electrode films can be produced from them.

The self-supporting electrode film 30 is generated more particularly in accordance with the method described in US 2013/0157141 A1. Here, dry and free-flowing particles of active material, binder, and additives are mixed with one another and compacted using a roll mill, for example, to give a self-supporting, in other words inherently stable, electrode film. Serving as binders are, in particular, “fibrillatable” polymers such as polytetrafluoroethylene (PTFE).

Fundamentally, in place of the self-supporting electrode film 30, a dry electrode mixture may also be employed, and may contain the same components as described above for the self-supporting electrode film 30.

In accordance with the present disclosure, the composite electrode 20 contains no adhesion promoters, meaning that no coating analogous to the primer coating 18 is provided (cf. FIG. 1).

Instead, sufficient adhesion of the electrode film 30 on the porous collector foil 22 is ensured by the electrode film 30 in the composite electrode 20 extending through the openings 24 of the porous collector foil 22. At the same time, the electrode film 30 very largely covers the top side 26 and the bottom side 28 of the porous collector foil 22.

Otherwise expressed, the contact area between the porous collector foil 22 and the electrode film 30 is higher—given the same external dimensions—than the available contact area between the collector foil 10, which has no openings, and the electrode film 12 from FIG. 1.

Moreover, the electrode film 30 is secured mechanically against slipping, warping or detaching, as indicated by double-ended arrows in FIG. 2.

The composite electrode 20 of the present disclosure therefore enables electrochemical cells having an increased energy density, as there is no need for primer coatings 18, which only represent dead material in terms of the maximum achievable energy density, without any need to accept losses in the durability and the mechanical robustness of the composite electrode 20.

The protruding region of the porous collector foil 22, being the region on which no electrode film 30 is applied, can be used later, in installed position, as a collector lug of the composite electrode 20.

There is no further limitation on the material of the porous collector foil 22. The porous collector foil 22 is made of copper or aluminum, for example.

In the first embodiment, the porous collector foil 22 is a perforated foil.

Represented in FIG. 3 is a second embodiment of the composite electrode 20 of the invention.

The second embodiment corresponds substantially to the first embodiment; below, therefore, only differences are addressed. Identical reference signs denote identical or functionally identical components, and the observations above are referenced.

In the second embodiment, the porous collector foil 22 is an expanded metal.

Expanded metals are inexpensively available worldwide and have a flexible mesh structure. In this way, particularly favorable mechanical interlocking is achieved between porous collector foil 22 and the electrode film 30.

Expanded metals are familiar from lightweight construction, for example.

A comparable structure may likewise be realized with a porous collector foil 22 composed of a metallized fabric.

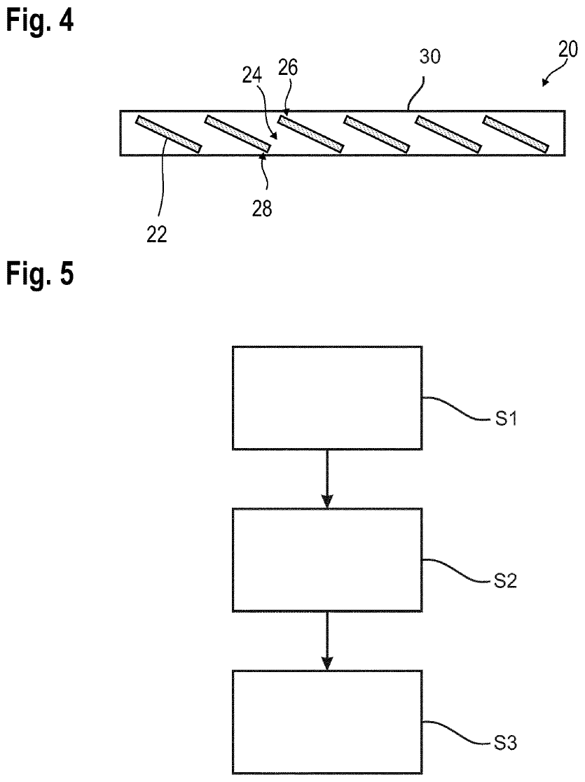

Represented in FIG. 4 is a third embodiment of the composite electrode 20 of the present disclosure.

The third embodiment corresponds substantially to the first and second embodiment; below, therefore, only differences are addressed. Identical reference signs denote identical or functionally identical components, and the observations above are referenced.

In the third embodiment, the porous collector foil 22 is a slit foil, and so the openings 24 extend slantways from the top side 26 to the bottom side 28 through the porous collector foil 22.

Elucidated in more detail below is a method of the present disclosure for producing an electrode, in other words, a composite electrode as described above, for an electrochemical cell.

First, the self-supporting electrode film 30 and the porous collector foil 22 are provided (steps S1 and S2 in FIG. 5, respectively).

The porous collector foil 22 may optionally be pretreated, by cleaning and/or surface activation of the porous collector foil 22, by corona surface treatment, for example.

The self-supporting electrode film 30 is subsequently applied to the porous collector foil 22 and compressed (step S3 in FIG. 5).

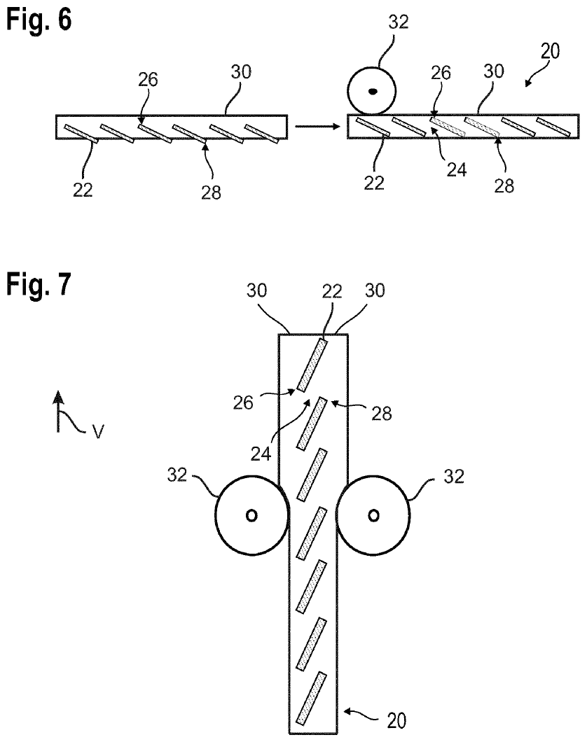

FIG. 6 shows, diagrammatically, selected method steps of a first embodiment of the method of the present disclosure.

In this embodiment, the self-supporting electrode film 30 is applied to the top side 26 of the porous collector foil 22 and then compressed by a calender roll 32.

The pressure force applied by the calender roll presses the electrode film 30 through the openings 24 and, after the compressing, this film 30 covers both the top side 26 and the bottom side 28 of the porous collector foil 22.

The calendering takes place preferably at a temperature in the range from 10° C. to 60° C., more particularly from 10° C. to 50° C., preferably from 15° C. to 30° C., more particularly at room temperature.

In principle it is also possible to press the electrode film 30 through the openings 24 not completely but only to an extent such that sufficient adhesion is produced between the electrode film 30 and the porous collector foil 22. In this case, a second electrode film 30 is subsequently applied to the opposite side of the porous collector foil 22 and likewise compressed.

FIG. 7 shows, schematically, the step of compressing the electrode film 30 in a second embodiment of the method of the present disclosure.

The second embodiment of the method of the present disclosure corresponds substantially to the first embodiment; below, therefore, only differences are addressed. The observations above are referenced.

In the second embodiment, an electrode film 30, also referred to below as first electrode film, is applied to the top side 26 of the porous collector foil 22 and an electrode film 30, also referred to below as second electrode film, is applied to the bottom side 28 of the porous collector foil 22, and the films are compressed by two opposite calender rolls 32 to give the composite electrode 20.

In this way, both the top side 26 and the bottom side 28 can be coated in a single method step, allowing the method duration in the production of the composite electrode 20 to be minimized.

Moreover, an operation of this kind can be carried out in a vertical operating regime. Expressed otherwise, the production process can be designed such that the composite electrode 20 is generated by movement opposite or along a vertical direction V; in FIG. 7, the as yet uncompressed region, represented at the top, of the composite electrode 20 is situated higher in geodetic terms than the already compressed region, represented at the bottom, of the composite electrode 20.

Described below is an experimental example of the method of the present disclosure for producing an electrode, in the example a cathode.

91 percent by weight of NMC 622 as active material, 5 percent by weight of PTFE as binder, and 4 percent by weight of conductive carbon black (Carbon Black Super C65), based in each case on the total weight of all the components, are mixed.

The PTFE binder here undergoes dry fibrillation, meaning that binder fibrils are shaped which knit with or bind to the further components of the mixture (as described in US 2013/00157141 A1). The mixture is calendered to form a self-supporting cathode film having a basis weight of 36 mg/cm² and an electrode density of 3.4 g/cm³.

The self-supporting cathode film thus generated is calendered to an expanded aluminum metal (having a thickness of about 38 μm), which serves as porous collector, at room temperature; after the calendering, the expanded metal collector is surrounded completely by the cathode film.

1-10. (canceled)

11. A method for producing a composite electrode for an electrochemical cell, comprising:
applying a self-supporting electrode film and/or a dry electrode mixture to a porous collector foil; and
compressing the self-supporting electrode film and/or the dry electrode mixture and the porous collector foil to form a composite electrode;
wherein the self-supporting electrode film and/or the dry electrode mixture comprises a multiplicity of dry-processed particles, the multiplicity of dry-processed particles containing at least a binder, a conductivity additive, and an active material;
wherein the porous collector foil has openings that extend through the porous collector foil;
wherein the electrode film or the dry electrode mixture is pressed at least partially into the openings of the porous collector foil; and
wherein the composite electrode is free from adhesion promoters.

12. The method according to claim 11, wherein the compressing comprises calendering.

13. The method according to claim 12, wherein the calendering comprises cold calendering at a temperature of from 10° C. to 60° C.

14. The method according to claim 11, wherein the porous collector foil is a perforated foil, a cut-out foil, an etched foil, a punched foil, a slit foil, an expanded metal, or a metallized fabric.

15. The method according to claim 11, wherein the porous collector foil is cleaned and/or surface-activated before the application of the self-supporting electrode film.

16. The method according to claim 11, wherein the porous collector foil is pretreated by a corona treatment or by plasma etching.

17. The method according to claim 11, wherein a first self-supporting electrode film is applied on a top side of the porous collector foil and a second self-supporting electrode film is applied on a bottom side of the porous collector foil, the bottom side opposite from the top side, and wherein both the first self-supporting electrode film and the second self-supporting electrode film are compressed on the porous collector foil.

18. The method according to claim 11, wherein the method is carried out without solvent.

19. The method according to claim 11, wherein the self-supporting electrode film has a density of 0.5 g/cm³ or higher.

20. The method according to claim 11, wherein the self-supporting electrode film comprises 30 to 98 percent by weight of graphite, 70 percent by weight or less of silicon, 9 percent by weight or less of carbon black, and 0.5 to 10 percent by weight of binder, based on the total weight of the self-supporting electrode film.

21. A composite electrode, obtainable by the method according to claim 11.

22. An electrochemical cell, comprising at least one composite electrode according to claim 21.

23. A composite electrode, comprising:
a porous collector foil, comprising a plurality of openings extending through the porous collector foil from a top side of the porous collector foil to a bottom side of the porous collector foil; and
a self-supporting electrode film and/or a dry electrode mixture, comprising a multiplicity of dry-processed particles, the multiplicity of dry-processed particles containing at least a binder, a conductivity additive, and an active material;
wherein the electrode film and/or the electrode mixture is adhered to the top side and/or the bottom side of the collector foil.

24. The composite electrode according to claim 23, wherein the porous collector foil is a perforated foil, a cut-out foil, an etched foil, a punched foil, a slit foil, an expanded metal, or a metallized fabric.

25. The composite electrode according to claim 23, wherein the porous collector foil comprises a protruding region to which no electrode film or electrode mixture is adhered.

26. The composite electrode according to claim 23, wherein the self-supporting electrode film has a density of 0.5 g/cm³ or higher.

27. The composite electrode according to claim 23, wherein the self-supporting electrode film comprises 30 to 98 percent by weight of graphite, 70 percent by weight or less of silicon, 9 percent by weight or less of carbon black, and 0.5 to 10 percent by weight of binder, based on the total weight of the self-supporting electrode film.

28. An electrochemical cell, comprising at least one composite electrode according to claim 23.
